(19) United States
(12) Patent Application Publication
(10) Pub. No.: US 2006/0286255 A1
(43) Pub. Date: Dec. 21, 2006

(54) Automated Soup Making Apparatus

(76) Inventors: Zhaoxia Xu, Ypsilanti, MI (US); Zheng Peng, Ypsilanti, MI (US)

Correspondence Address: ZHAOXIA XU, 4694 SYCAMORE DR., YPSILANTI, MI, 48197, US

(21) Appl. No.: 11/160,319

(22) Filed: Jun. 18, 2005

(51) Int. Cl. A23L 1/40

(52) U.S. Cl. 426/589

(57) ABSTRACT

An automated soup making apparatus (100). Apparatus (100) comprises a container (102) having an open top for holding foods, a cap (104) removably installed on the top of container (102), a heating element (110) for heating foods disposed inside container (102), a blade (108) installed inside container (102) for chopping foods, a base (116) disposed underneath container (102) for supporting container (102), a motor (118) installed inside base (116) and operationally coupled with blade (108) for driving blade (108) through repeating chopping cycles. Apparatus (100) incorporates chopping and cooking of foods into one single apparatus for making soups. Other benefits include temperature control for optimized heating or chopping of foods, automated stirring for uniform heating and minimized risk of burning of foods, and spillage prevention.

### BACKGROUND OF THE INVENTION

1. Field of Invention

This invention generally relates to cooking/food processing apparatuses. More specifically, this invention relates to soup making apparatuses.

2. Prior Art

For centuries, soup has been the first resort of a special dinner. Soups are not just delicious. They are comforting and warming in the winter and cooling and refreshing in the summer.

People sip, slurp, and spoon soup not only for basic sustenance, but also to stay healthy. Cooking vegetables in water releases their healing bioflavonoid into the liquid without destroying their powerful antioxidant properties. Soups that feature vegetables, beans, or rice add fiber and nutrients to the diet.

Small children at their early ages are relying on liquid foods, such as soups. Some senior population prefers liquid foods or soups due to their reduced digestive capability.

Soups are either made from scratch or are prepared from a canned soup product. As might be expected, the traditional way of preparing soups from scratch or from a can has distinct disadvantages and drawbacks.

For example, in the case of canned soups, the entire contents of the can must be heated regardless of the number of servings desired. Similarly, in the case of soup made from scratch, a large quantity must be prepared. Invariably, a certain portion of the soup remains unused and oftentimes is discarded. The aforementioned problems are further compounded when more than one type of soups are served.

Another distinct disadvantage involves the amount of time necessary to prepare soups. Commonly used soup cooking apparatuses are slow cookers or the likes. Soups are cooked at low temperature for extended time, for example, several hours. This is to reduce the requirement of attendance, for example, to avoid spillage, to minimize the requirements on stirring, etc., but significant time is required. As a matter of fact, the longer the soup is cooked, the more nutrients are lost. Extended cooking will also damage the texture of foods, especially for vegetables.

Thirdly, periodic stirring is required to assure uniform cooking of the entire container's contents and to avoid the burning of foods on the container bottom. As a result, extensive efforts have to be spent. Steam cooking of soups is used in some commercial equipment to avoid burning of foods, but the equipment is prohibitively expensive and, obviously, is not quite suitable for household use.

The problem is getting even worse when baby foods are prepared. Baby foods are normally cooked for longer time to soften foods to an extent suitable for babies. In order to shorten the process, quite often, foods are mixed and blended before or after boiling or cooking. Constant stirring and checking on potential spillage are required. This two-step soup making process, namely, cooking and then chopping separately, is time consuming and inconvenient.

In order to solve the afore-mentioned problems, some patents have been granted. The followings are two typical ones.

U.S. Pat. No. 6,065,861, issued to Chen on May 23, 2000, describes a soup making apparatus, which can perform blending and boiling functions so as to separate dregs from juice or soup to produce an edible soup or juice. The proposed apparatus has two containers. Users can use one container to initially separate juice or soup from undesired solids and then transfer the soup or juice into the other container, a heating container, to boil the same.

There are important drawbacks associated with the apparatus proposed in U.S. Pat. No. 6,065,861. First, users have to use one container for separating the juice or soup from undesired dregs and the other one to boil the same; which involves an inconvenient two-step operation. Second, there is high risk of spillage if the apparatus is left unattended while being used for boiling soup or juice. Third, two containers are necessary, whereby the apparatus is fairly large; which renders it unappealing, especially for household applications. Fourth, constant stirring might be necessary to avoid burning of foods on the bottom of the container.

U.S. Pat. No. 4,817,510, issued to Kowalics, et al., on Apr. 4, 1989, describes a soup cooking apparatus, into which air is supplied for mixing or stirring purposes. However, users have to prepare raw foods for making soups, for example, chopping foods. Even as claimed by the inventors that the bubbling introduced by the supplied air may serve as a stirring mechanism, users still have to attend the apparatus because spillage might occur when the soup is boiling. Further more, supplying air into the fluid container would require an air pump, which complicates the system, resulting in a more expensive product.

Blenders are widely used for processing foods and many patents have been granted. However, for the purpose of making soups, blended foods have to be transferred to a cooking pot for proper cooking. The two separate operations would require large space and multiple cooking utensils or appliances, and obviously, more time and efforts are required for the whole cooking process.

Therefore, it remains desirable to provide soup making apparatuses that have an automated stirring mechanism for hands free soup making, that combine the chopping and heating of foods in one single appliance or equipment for saving time and efforts, that can detect potential spillage and avoid the same for unattended cooking, and that are highly efficient in heating foods and fast in making soups.

### BRIEF SUMMARY OF THE INVENTION

Accordingly, the present invention is an automated soup making apparatus. This soup making apparatus comprises a container having an open top for holding foods, a cap installed on the top of the container for closing up the open top thereof, a heating element for heating foods disposed inside the container, a chopping blade removably installed inside the container for chopping foods, a motor operationally coupled with the chopping blade for driving the chopping blade through repeating chopping cycles. Additionally, there are provided a temperature sensor for monitoring the temperature of foods for optimized heating of foods and a spillage-preventing device to prevent spillage from happening.

The chopping blade sweeps across food pieces in an intermittent operation, in which it dwells for a predetermined dwell period near the end of each chopping cycle. This intermittent operation affords relief of the motor from constant chopping of foods at a super high speed, thereby extending the utility life of the motor. When rotating at a relatively lower speed, the chopping blade serves as a stirrer for more uniform heating and for avoiding local burning of foods.

The heating element boils foods in an intermittent operation. The intermittent heating of foods is provided to further reduce the risk of local overheating or burning of foods.

Accordingly, the followings are some of the objects, features, and advantages of the present invention.

It is an object of the present invention to provide a soup making apparatus for use to prepare tasteful soups.

It is another object of the present invention to provide a “One Touch for All” soup making apparatus.

It is a further more object of the present invention to provide a soup making apparatus that cooks soups faster and saves time.

It is a still further more object of the present invention to provide a soup making apparatus that can be conveniently used to prepare foods for babies and elderly people who suffer from reduced digestive capability.

It is a feature of the present invention that this soup making apparatus has a chopping blade removably installed inside a container for chopping foods. The blade sweeps across food pieces at a predetermined high speed to chop foods. The same blade also serves as a stirrer when rotating at a relatively lower speed for high efficient heat transferring and uniform cooking.

It is another feature of the present invention that this soup making apparatus has a spillage prevention mechanism to avoid potential spillage for worry-free cooking.

It is a further more feature of the present invention that the heating element is immersed into the soup such that the heating efficiency is extraordinarily high, as a result, saving time and energy.

It is an advantage of the present invention that this soup making apparatus is virtually hands free for making soups.

It is another advantage of the present invention that this soup making apparatus is highly efficient in heating foods and faster in making soups.

It is a further more advantage of the present invention that this soup making apparatus provides large value to businesses and general public, as well, in making soups.

Further more features and advantages of the present invention will be readily appreciated, as the same becomes better understood after reading the subsequent description when considered in connection with the accompanying drawings.

### BRIEF DESCRIPTION OF THE DRAWING

FIG. 1 illustrates a cross-sectional view of an embodiment of the present invention, a soup making apparatus 100.

FIG. 2 illustrates an exploded cross-sectional view of blade 108 and the neighboring components in FIG. 1.

FIG. 3 illustrates a blocked diagram of control circuit 142 for soup making apparatus 100.

FIG. 4 illustrates a perspective view of soup making apparatus 100.

FIG. 5 illustrates a blocked diagram of a soup making process 180.

FIG. 6 illustrates a cross-sectional view of an alternative design of soup making apparatus 100 in FIG. 1, soup making apparatus 100a.

FIG. 7 illustrates a cross-sectional view of another embodiment of the present invention, a soup making apparatus 200.

FIG. 8 illustrates an exploded cross-sectional view of blade 208 and the neighboring components in FIG. 7.

### DETAILED DESCRIPTION OF THE INVENTION

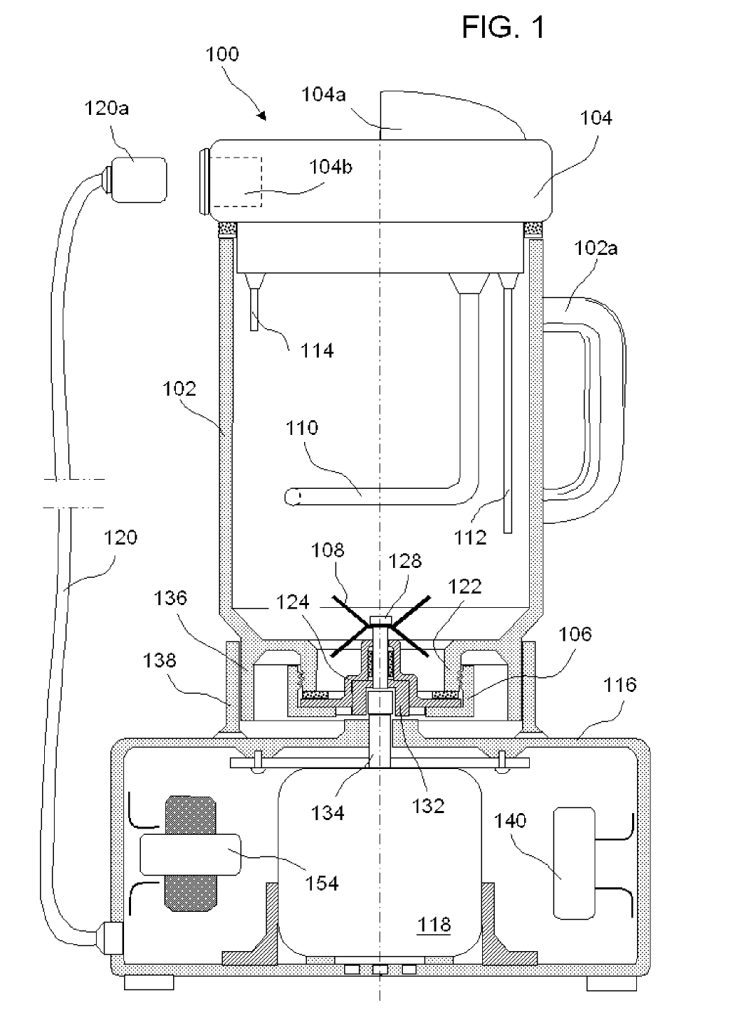

Reference is made to FIG. 1, which illustrates a cross-sectional view of an embodiment of the present invention, a soup making apparatus 100. Apparatus 100 comprises a container 102, a top cap 104, a bottom cap 106, a chopping blade 108, a heating element 110, a temperature sensor 112, a spillage preventing sensor 114, a base 116, a motor 118, and a cable 120.

Container 102, having an open top and an open bottom, is provided for holding foods. A grasp handle 102a is fixedly installed on the sidewall of container 102 for use of handling container 102. Cap 104 is removably installed on the top of container 102 for closing up the open top thereof. A cap handle 104a is provided on the top of cap 104 for use of handling cap 104. Cap 106, removably engaged with a cylindrical wall 122 emanating from the bottom of container 102 downwards, is provided for closing up the open bottom thereof and holding blade 108 in position. Wall 122 forms the open bottom of container 102 and has a cylindrical configuration.

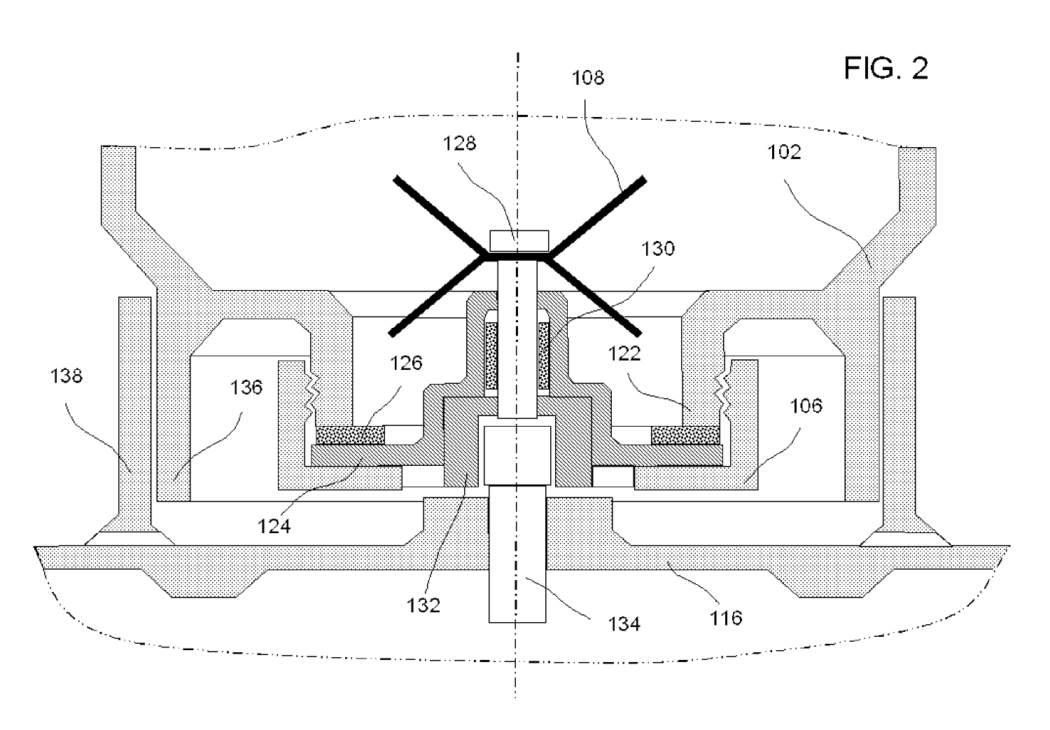

As more clearly illustrated in FIG. 2, which illustrates an exploded cross-sectional view of blade 108 and the neighboring components in FIG. 1, blade 108 is installed on the bottom of container 102 through a seal housing 124. The bottom of housing 124 has a circular flat configuration, which fits into the bottom of cap 106. When cap 106 is tightened onto the bottom of container 102 through screws thereof, housing 124 is held in position in between the horizontal bottom surface of wall 122 and the bottom of cap 106. A first seal 126 is disposed in between housing 124 and wall 122 for sealing off the interface thereof. Blade 108 is fixedly engaged with the upper portion of a blade shaft 128, which extends downwards into housing 124. A second seal 130 creates a seal by being squeezed against housing 124 and shaft 128 to seal off the interface thereof. A coupling element 132, fixedly engaged with the lower portion of shaft 128, removably receives the square head of a motor shaft 134 for transferring rotating force.

Reference is made to FIG. 1, again. Heating element 110, installed on the bottom of cap 104, is provided for heating foods disposed inside container 102. Heating element 110, an electrical resistance type heater, extends downwards into container 102 and is immersed into foods to be cooked.

Temperature sensor 112 is provided for measuring the temperature of foods. Sensor 112 is installed on the bottom of cap 104 and extends downwards into container 102. The lower portion of sensor 112 is immersed into foods.

Spillage-preventing sensor 114 is provided for detecting and preventing potential spillage. Sensor 114 is installed on the bottom of cap 104 and protrudes downwards. Sensor 114 is disposed above foods with a predetermined clearance. When spillage is about to happen, the bubbles of foods are in contact with sensor 114. Either the temperature is measured or an electric potential or current is generated. The signal is then sent to a control module 140 of apparatus 100 to shut off the electrical power to heating element 110 to prevent the spillage from happening.

Base 116 is provided for supporting container 102 from the bottom and for housing motor 118. An outer wall 136 of the bottom portion of container 102 sits into an upstanding cylindrical wall 138, which is installed on the top surface of base 116. When container 102 being locked in position, coupling element 132 is in the position to removably receive the square head of shaft 134.

Motor 118 is installed inside base 116. Motor shaft 134 extends upwards through an aperture on the top surface of base 116. The square head of shaft 134 is removably engaged with coupling element 132.

Cable 120 is provided for transferring electrical power to heating element 110 from base 116 and for the communication of signals between control module 140 and sensors 112 and 114. A connector 120a is fabricated onto the upper end of cable 120 and is adapted to removably engage with a terminal 104b, which is installed on the side of cap 104.

Control module 140, installed inside housing 116, is provided for controlling various functions of apparatus 100.

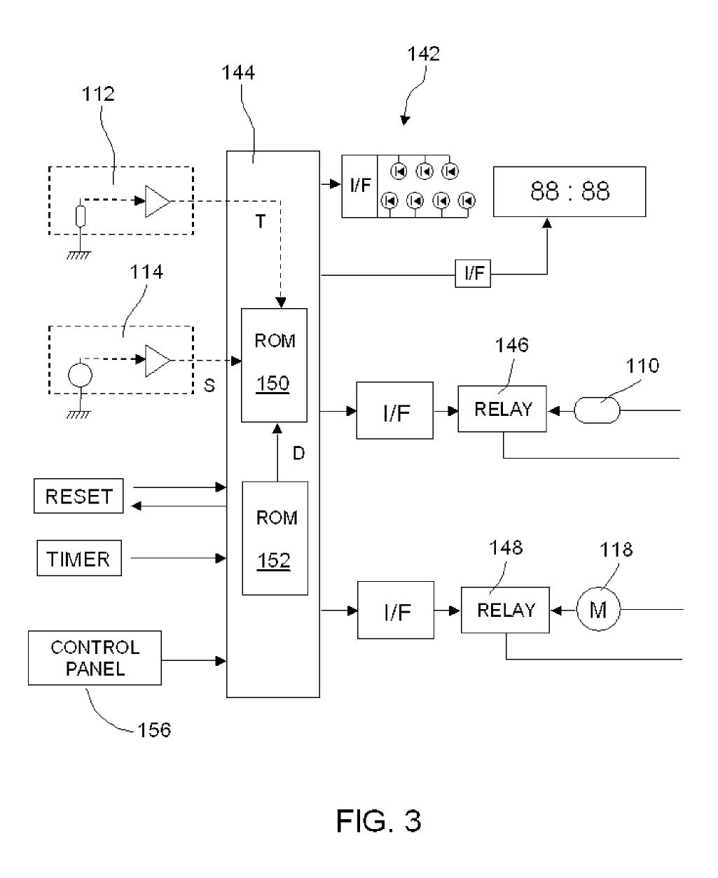

Control module 140 includes a control circuit 142, as the blocked diagram shown in FIG. 3. Circuit 142 comprises a microcomputer 144, which controls various functions of apparatus 100, a relay 146, which activates heating element 110, and a relay 148, which activates motor 118.

Microcomputer 144 is provided with ROM and RAM for data memory, and further provided with I/O ports and A/D converters as interfaces. The aforementioned ROM's comprises a ROM 150 containing control programs related to the performance of all the soup making processes and a ROM 152, which memorizes referenced data.

The temperature signal from sensor 112 is taken by microcomputer 144. The signal is used for controlling heating element 110 and/or motor 118.

Spillage signal from sensor 114 is fed into computer 144 and is used to control heating element 110. Once a potential spillage is detected, heating element 110 is immediately shut off.

Computer 144 can be such programmed that relay 146 activates heating element 110 intermittently, such that the soup is moderately heated each time to avoid burning of foods onto heating element 110. This intermittent heating allows more time for the heat generated to transfer to foods. Similarly, relay 148 activates motor 118 intermittently to achieve intermittent chopping and stirring of foods.

A transformer 154, as shown in FIG. 1, is installed inside base 116. Transformer 154 provides electrical power to control circuit 142 and elements, like indicators, beepers, LCD, etc.

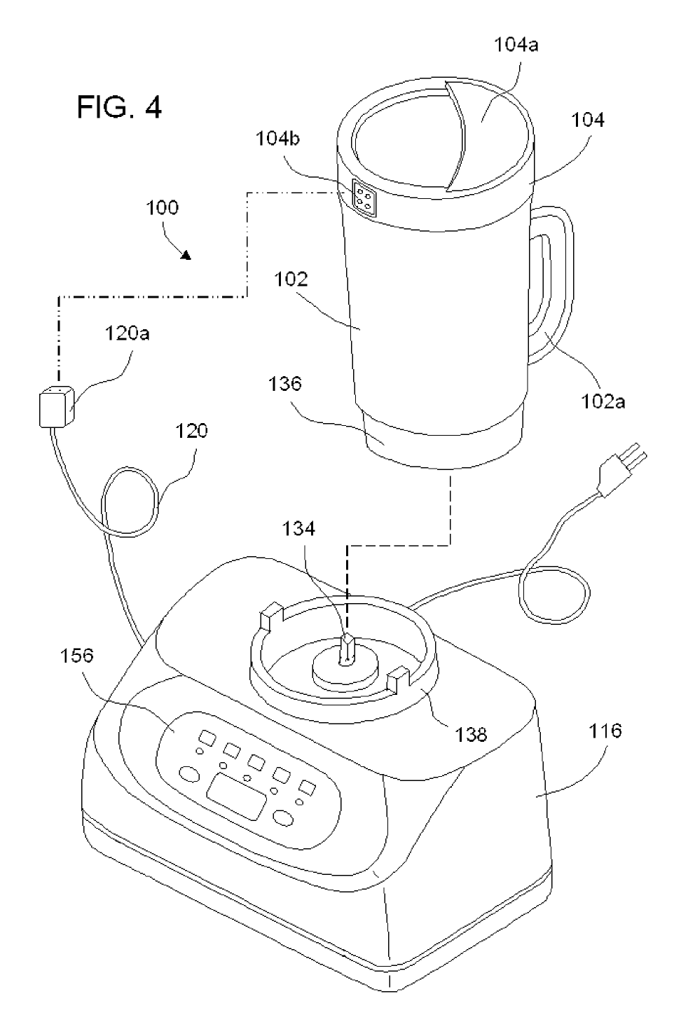

A control panel 156, attached to base 116, as more clearly shown in FIG. 4, is provided for supporting elements, like switches, indicators, adjusting knobs, beepers, LCD, and so on.

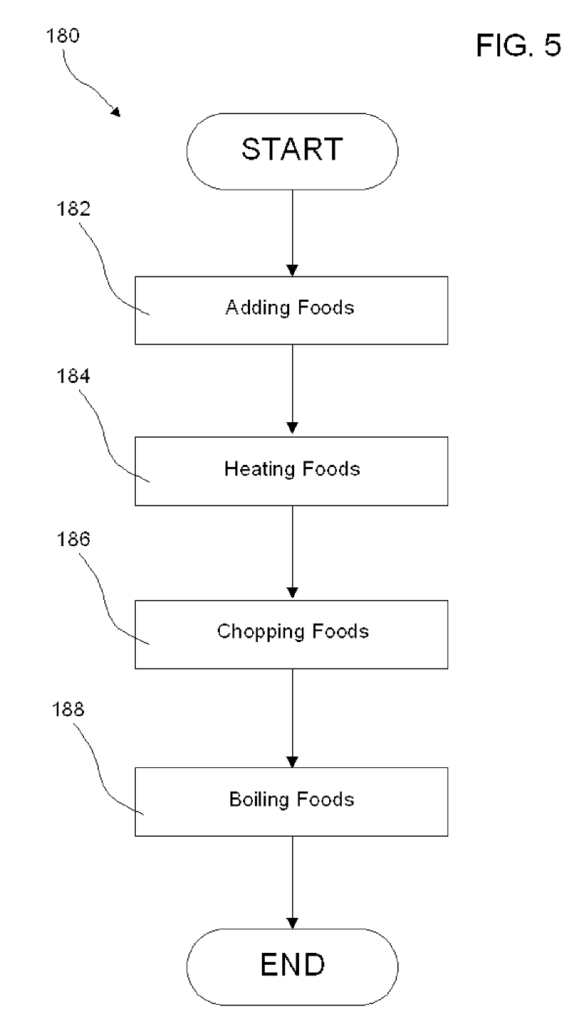

Reference is made to FIG. 5, which illustrates a blocked diagram of a soup making process 180, using soup-making apparatus 100. Process 180 includes the steps of adding foods 182, heating foods 184, chopping foods 186, and boiling foods 188.

The step of adding foods 182: A user first installs container 102 on base 116; second, adds foods, such as vegetables, meats, spices, soaked beans, soaked rice, etc., into container 102; third, adds water into container 102 up to the recommended level; fourth, assembles cap 104 on the top of container 102; fifth, hooks up cable 120; sixth selects a soup making program and executes the same.

The step of heating foods 184: Heating element 110 starts to heat foods to a predetermined temperature, which is, preferably, close to the boiling temperature, e.g., 70° C. to 100° C. During this stage, since the soup is not cooked or thick yet, heating element 110 can heat foods with full power and bring the temperature to the predetermined one in as short time as possible.

The step of chopping foods 186: Blade 108 starts to chop foods. The whole chopping process is divided into a plurality of chopping cycles. Within each chopping cycle, blade 108 chops foods for a predetermined time interval, e.g., 10 to 50 seconds, and then dwells for a predetermined time interval, e.g., 10 to 50 seconds. This intermittent chopping process affords relief of constant working of motor 118 at a super high speed, and as a result, extends the utility life of motor 118. Additionally, the intermittent chopping of foods favors better chopping of foods because it allows larger food pieces to settle down before the next chopping cycle starts.

The step of boiling foods 188: The chopped foods have to be brought to boiling for a predetermined time period for proper cooking. However, the foods now have been smashed and fully mixed with water. This mixture of foods and water has become much thicker. There are some issues associated with boiling this food mixture. Potential issues include burning of foods onto heating element 110 and uneven heating of foods. In order to solve these problems, an intermittent heating of foods is proposed in this invention disclosure. In this intermittent heating of foods, the whole heating process is divided into a plurality of heating cycles. Within each heating cycle, heating element 110 heats foods for a predetermined time interval, e.g., 5 to 30 seconds, and then dwells for a predetermined time interval, e.g., 10 to 30 seconds. This intermittent heating process allows the heat generated while heating element 110 is in working to dissipate to foods during the time heating element 110 dwells.

In another aspect, to facilitate the heat transferring or more even heating of foods, it is desired that foods move while being heated. A stirring mechanism is proposed in this invention disclosure. In this stirring mechanism, blade 108 sweeps across foods at a predetermined lower speed. In this case, blade 108 serves as a stirrer to bring foods into moving while the same being heated. Better heat transferring will also reduce the risk of burning of foods onto heating element 110.

Further chopping can be provided after the step of boiling foods 188 is satisfactorily accomplished. Apparatus 100 can provide a mixing or chopping function for advanced users to give them the flexibility to add more spices, soup thickening ingredients, etc., in an effort to further enhance the quality of the soup being made after soup making process 180 has been successfully executed.

In operation, a user: first, installs container 102 on base 116 and adds foods and water into container 102; second, installs cap 104 on the top of container 102 and hooks up cable 120; third, selects a soup making program; fourth, pushes on the “START” button to execute the soup making program selected.

The whole process is hands free. Apparatus 100 will beep to remind the user when a soup is ready for serving.

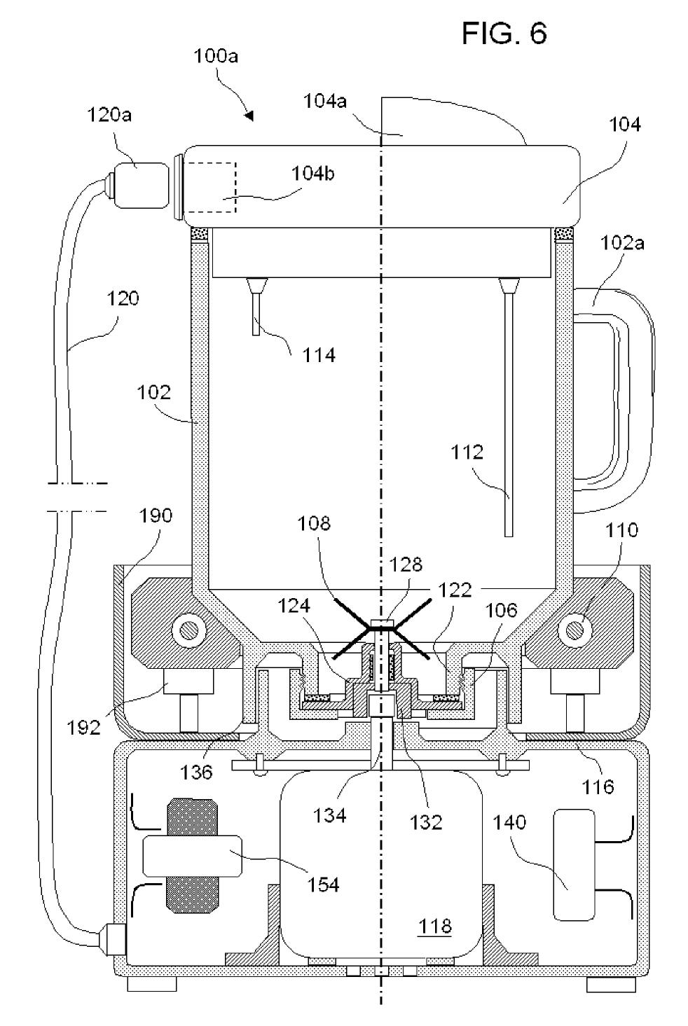

FIG. 6 illustrates a cross-sectional view of an alternative design of soup making apparatus 100 in FIG. 1, a soup making apparatus 100a. In apparatus 100a, heating element 110 is disposed underneath the bottom of container 102. An outer pot 190, having an open top and an open bottom, is fixedly installed on the upper surface of base 116. Heating element 110 is installed inside pot 190 via a heater support 192. When container 102 is locked into its working position, the outer rim of the bottom of container 102 sits right on heating element 110, such that the heat transfer is accomplished through the contacting surface therebetween. Other features of apparatus 100a are similar to those of apparatus 100. Reference is made to apparatus 100 for more detailed information.

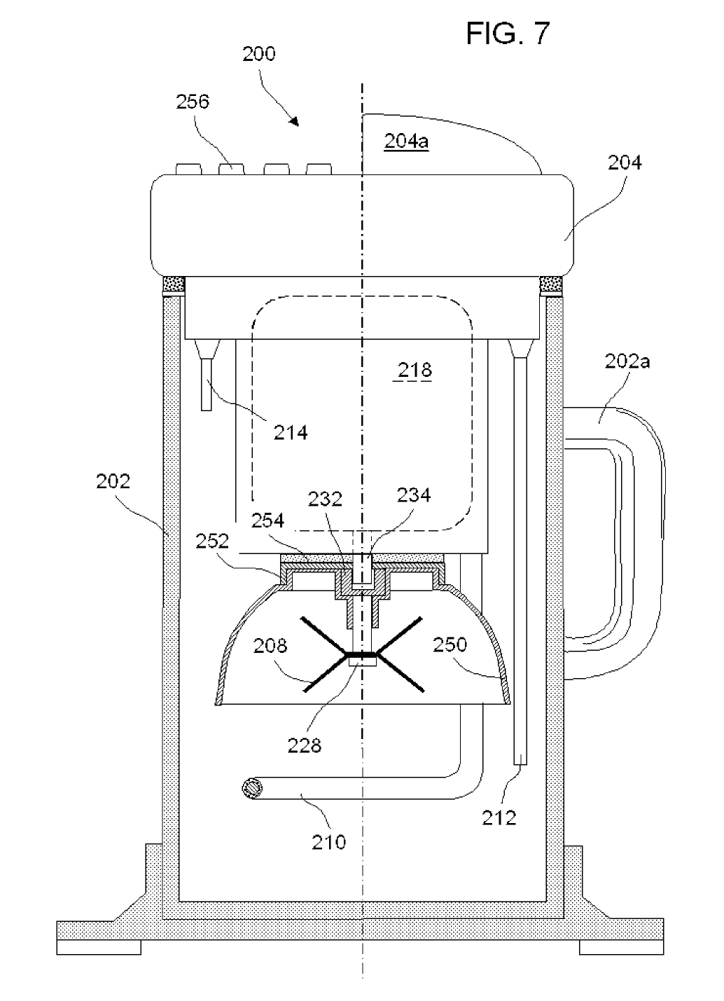

Reference is made to FIG. 7, which illustrates a cross-sectional view of another embodiment of the present invention, a soup making apparatus 200. Apparatus 200 comprises a container 202, a main body 204, a chopping blade 208, a heating element 210, a temperature sensor 212, a spillage preventing sensor 214, and a motor 218.

Container 202, having an open top, is provided for holding foods. A grasp handle 202a is fixedly installed on the sidewall of container 202 for use of handling container 202. Main body 204 is removably installed on the top of container 202 for closing up the open top thereof. A handle 204a is installed on the top of main body 204 for use of handling main body 204.

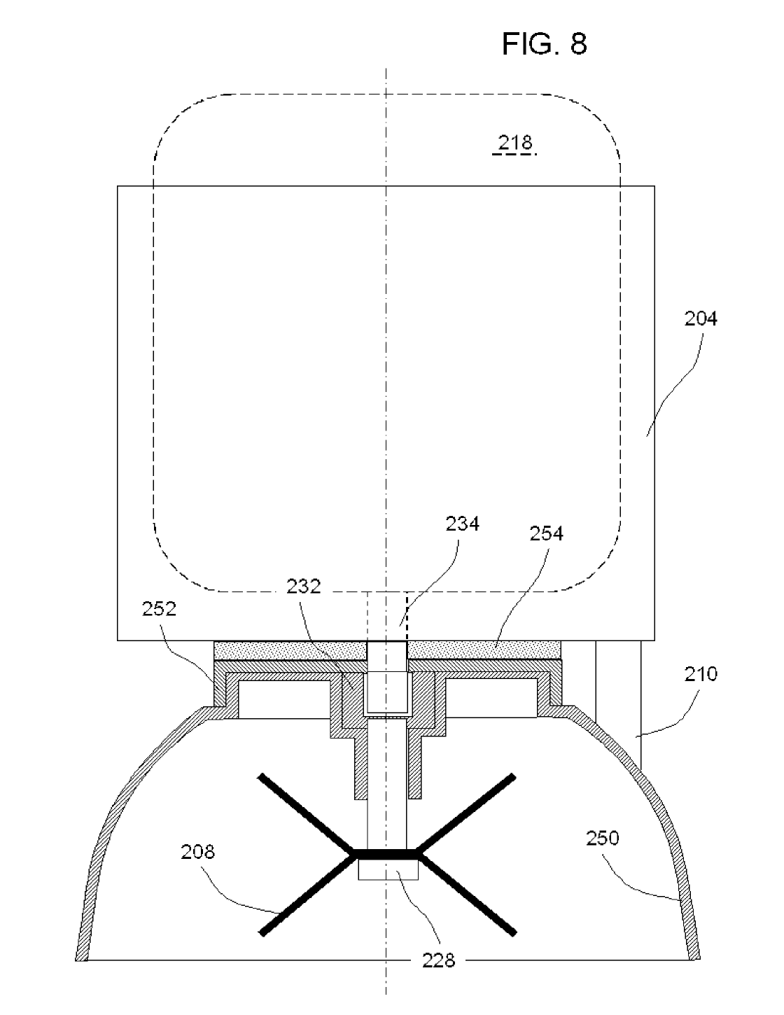

As more clearly illustrated in FIG. 8, which illustrates an exploded cross-sectional view of blade 208 and the neighboring components in FIG. 7, blade 208 is installed on the bottom of main body 204 and extends downwards into container 202. Blade 208 is engaged with the lower portion of a blade shaft 228 and disposed inside foods. The upper portion of shaft 228 is fixedly engaged with a coupling element 232, which removably receives the square head of a motor shaft 234 for transferring rotating force.

A safety cup 250 is provided for safeguarding blade 208. Cup 250 is lockably installed onto an adapter 252, which is fixedly installed on the bottom of main body 204. A seal 254 is disposed in between adapter 252 and the bottom of main body 204 for sealing off the interface thereof to prevent moisture from permeating into the inside of main body 204.

Reference is made to FIG. 7, again. Heating element 210, installed on the bottom of main body 204, is provided for heating foods disposed inside container 202. Heating element 210, an electrical resistance type heater, extends downwards into container 202 and is immersed into foods to be cooked.

Temperature sensor 212 is provided for measuring the temperature of foods. Sensor 212 is installed on the bottom of main body 204 and extends downwards into container 202. The lower portion of sensor 212 is immersed into foods.

Spillage-preventing sensor 214 is provided for detecting and preventing potential spillage. Sensor 214 is installed on the bottom of main body 204 and protrudes downwards. Sensor 214 is disposed above foods with a predetermined clearance.

Control panel 256 is installed on the top of main body 204.

Motor 218 is installed inside main body 204. Motor shaft 234 extends downwards through an aperture on the floor of main body 204. The square head of shaft 234 removably engages with coupling element 232.

Other features of apparatus 200 are similar to apparatus 100. Reference is made to apparatus 100 for more detailed information.

Accordingly, readers will see that this soup making apparatus of the present invention can be used to prepare tasteful soups. The whole process is virtually hands free.

The soup making apparatus proposed by the present invention combines the cooking and chopping of foods together into one single apparatus, thereby saving time and minimizing human involvement and chore.

The chopping blade sweeps across food pieces intermittently. This intermittent operation favors better chopping of food pieces and relief of the high-speed motor from constant working. When the chopping blade rotates across foods at a lower speed, it serves as a stirrer to facilitate uniform heating of foods and to minimize the risk of burning of foods onto the heating element.

The heating element boils foods in an intermittent operation. This intermittent operation allows the heat generated to dissipate to foods while the heating element dwells, as a result, reduces the risk of burning of foods onto the heating element.

The present invention has been described in an illustrative manner. It is to be understood that the terminology, which has been used, is intended to be in the nature of words of description rather than of limitation.

Although this invention has been described in its preferred forms and structures with a certain degree of particularity, these should not be construed as limiting the scope of the invention but as merely providing illustrations of some of the presently preferred embodiments of this invention.

Thus it is understood that the present disclosure of the preferred forms can be changed in the details of construction and in the combination and arrangement of parts without departing from the spirit and the scope of the invention as hereinafter claimed.

What is claimed is:

1. An automated soup making apparatus, said automated soup making apparatus comprising:
a container having an open top for holding foods;
heating means for heating foods disposed inside said container;
blade means installed inside said container for chopping foods; and
a motor operationally coupled with said blade means for driving said blade means through repeating chopping cycles.

2. An automated soup making apparatus as defined in claim 1, said automated soup making apparatus further including a temperature sensor for detecting the temperature of foods, thereby controlling said heating means or said blade means for optimized heating or chopping of foods.

3. An automated soup making apparatus as defined in claim 1, said automated soup making apparatus further including a spillage preventing mechanism for detecting and preventing potential spillage.

4. An automated soup making apparatus as defined in claim 1, wherein said motor provides at least two rated rotation speeds, one predetermined higher speed for chopping foods and one predetermined lower speed for stirring foods.

5. An automated soup making apparatus as defined in claim 1, wherein said heating means heats foods in a plurality of heating cycles, such that within each heating cycle said heating means heats foods for a predetermined time interval and then dwells for a predetermined time interval, thereby allowing the heat generated to dissipate to foods while said heating means dwells.

6. An automated soup making apparatus as defined in claim 1, wherein said blade means chops foods in a plurality of chopping cycles, such that within each chopping cycle said blade means chops foods for a predetermined time interval and then dwells for a predetermined time interval.

7. An automated soup making apparatus as defined in claim 1, said automated soup making apparatus further including a main body removably installed on the top of said container and wherein said motor is installed inside said main body.

8. An automated soup making apparatus as defined in claim 7, said automated soup making apparatus further including a temperature sensor installed on the bottom of said main body extending downwards into said container for detecting the temperature of foods, thereby controlling said heating means or said blade means for optimized heating or chopping of foods.

9. An automated soup making apparatus as defined in claim 7, said automated soup making apparatus further including a spillage preventing mechanism installed on the bottom of said main body protruding downwards for detecting and preventing potential spillage.

10. An automated soup making apparatus as defined in claim 7, wherein said motor provides at least two rated rotation speeds, one predetermined higher speed for chopping foods and one predetermined lower speed for stirring foods.

11. An automated soup making apparatus as defined in claim 7, wherein said heating means heats foods in a plurality of heating cycles, such that within each heating cycle said heating means heats foods for a predetermined time interval and then dwells for a predetermined time interval, thereby allowing the heat generated to dissipate to foods while said heating means dwells.

12. An automated soup making apparatus as defined in claim 7, wherein said blade means chops foods in a plurality of chopping cycles, such that within each chopping cycle said blade means chops foods for a predetermined time interval and then dwells for a predetermined time interval.

13. An automated soup making apparatus as defined in claim 7, said automated soup making apparatus further including a safety cup removably installed on the bottom of said main body for safeguarding said blade means against potential injuries to users, wherein a blade shaft is installed on said safety cup and removably coupled with a motor shaft from said motor, wherein said blade means is installed on the lower portion of said blade shaft, and whereby said blade means together with said safety cup is removable for ease of cleaning after use.

14. An automated soup making apparatus, said automated soup making apparatus comprising:
a container having an open top and an open bottom for holding foods;
a top cap removably installed on the top of said container;
a bottom cap removably installed on the bottom of said container for closing up the open bottom of said container;
heating means for heating foods disposed inside said container;
blade means installed inside said container for chopping foods;
a base disposed underneath said container for supporting said container;
a motor installed inside said base and operationally coupled with said blade means for driving said blade means through repeating chopping cycles; and
a linkage mechanism communicating between said top cap and said base, thereby transferring electrical power or control signals in between said top cap and said base.

15. An automated soup making apparatus as defined in claim 14, said automated soup making apparatus further including a temperature sensor installed on the bottom of said top cap extending downwards into said container for detecting the temperature of foods, thereby controlling said heating means or blade means for optimized heating or chopping of foods.

16. An automated soup making apparatus as defined in claim 14, wherein said heating means is installed on the bottom of said top cap extending downwards into said container for heating of foods.

17. An automated soup making apparatus as defined in claim 14, wherein said heating means is disposed underneath said container for heating of foods.

18. An automated soup making apparatus as defined in claim 14, said automated soup making apparatus further including a spillage preventing mechanism installed on the bottom of said top cap protruding downwards for detecting and preventing potential spillage.

19. An automated soup making apparatus as defined in claim 14, wherein said motor provides at least two rated rotation speeds, one predetermined higher speed for chopping foods and one predetermined lower speed for stirring foods.

20. An automated soup making apparatus as defined in claim 14, wherein said heating means heats foods in a plurality of heating cycles, such that within each heating cycle said heating means heats foods for a predetermined time interval and then dwells for a predetermined time interval, thereby allowing the heat generated to dissipate to foods while said heating means dwells.

21. An automated soup making apparatus as defined in claim 14, wherein said blade means chops foods in a plurality of chopping cycles, such that within each chopping cycle said blade means chops foods for a predetermined time interval and then dwells for a predetermined time interval.

22. An automated soup making apparatus as defined in claim 14, wherein said blade means is held in position by said bottom cap when said bottom cap is tightened onto the bottom of said container, whereby said blade means is removable for ease of cleaning after use.

23. A method of making soups including the following steps:
providing a soup making apparatus, wherein said soup making apparatus includes a container having an open top for holding foods, heating means for heating foods disposed inside said container, blade means installed inside said container for chopping foods, and a motor operationally coupled with said blade means for driving said blade means through repeating chopping cycles;
adding foods into said container;
heating foods until a predetermined temperature is reached;
chopping foods until desired chunkiness is reached; and
boiling foods for a predetermined time interval or until foods are properly cooked.

24. A method of making soups as defined in claim 23, wherein said step of boiling foods includes a heating operation and a stirring operation, wherein said stirring operation is concurrent with said heating operation to facilitate fluid flow while said heating operation is on going, thereby promoting uniform heating of foods and minimizing the risk of burning of foods.

25. A method of making soups as defined in claim 23, wherein said step of chopping foods includes a plurality of chopping cycles and wherein within each chopping cycle, said blade means chops foods for a predetermined time interval and then dwells for a predetermined time interval.

26. A method of making soups as defined in claim 23, wherein said step of boiling foods includes a plurality of heating cycles and wherein within each heating cycle, said heating means heats foods for a predetermined time interval and then dwells for a predetermined time interval, thereby allowing more time for the heat generated to dissipate to foods while said heating means dwells.
